(19) United States
(12) Patent Application Publication
(10) Pub. No.: US 2026/0106672 A1
(43) Pub. Date: Apr. 16, 2026

(54) Single-Sideband Generator Based on Optical Delay Line

(71) Applicant: City University of Hong Kong, Hong Kong (HK)

(72) Inventors: Yikun CHEN, Hong Kong (HK); Ke ZHANG, Hong Kong (HK); Hanke FENG, Hong Kong (HK); Cheng WANG, Hong Kong (HK)

(21) Appl. No.: 18/914,303

(22) Filed: Oct. 14, 2024

(51) Int. Cl. H04B 10/516

(52) U.S. Cl. CPC H04B 10/5165

(57) ABSTRACT

The present invention provides a single sideband signal generator including a modulator configured to generate a first and a second modulated optical signals which have equal amplitudes but opposite phases; a first optical delay line-based sideband suppressing optical circuit for generating a full-carrier single sideband signal and/or a second optical delay line-based sideband suppressing optical circuit for generating a carrier-suppressed single sideband signal. The present invention simplifies the structure by saving half of the space occupied by the redundant signal electrodes and also reducing the RF power consumption by half by removing the RF hybrid. The provided single sideband signal generator can enable compact, low-cost, and power-efficient SSB signal generation and be easily scaled to higher frequency domains without additional cost by appropriately designing the optical delay line length.

### FIELD OF THE INVENTION

The present invention generally relates to generation of single sideband (SSB) optical signals. More specifically the present invention relates to a SSB signal generator based on optical delay line.

### BACKGROUND OF THE INVENTION

The ever-growing data transmission demand for applications such as 5G/6G networks, Internet of Things (IoT), Massive Multiple Input Multiple Output (MIMO) and Radio-over-Fiber (RoF) systems imposes significant pressure on base stations and data center infrastructure. Direct detection systems, which only needs photodiode to receive signals, offer advantages of low cost and simplicity compared to coherent detection systems. However, the general double sideband signal suffers from limited transmission distance due to dispersion-induced frequency selective power fading. SSB signaling can provide a solution to this problem while also improving spectral efficiency.

Typical SSB modulators rely on complex implementations like dual-drive parallel phase modulators [in the case of dual-drive Mach-Zehnder modulators (DDMZM), for full-carrier SSB (FC-SSB)] or amplitude modulators [in the case of in-phase/quadrature (IQ) modulators, for carrier-suppressed SSB (CS-SSB)], which require two radio-frequency (RF) signals with a 90° phase difference applying onto two signal electrodes. The requirement of 90° RF hybrid (RF Hilbert transformer) or dual-channel RF source [e.g., dual-channel arbitrary waveform generator (AWG)] and the complex parallel electrodes leads to 3 dB attenuation in modulation efficiency, intrinsic RF loss and cost, especially severe at high frequency.

FIG. 1 illustrates the schematic diagrams of conventional full-carrier SSB (FC-SSB) modulation based on a dual-drive Mach-Zehnder modulator (DDMZM) and carrier-suppressed SSB (CS-SSB) modulation using an IQ modulator. These techniques typically require two sets of parallel phase or amplitude modulators, with two branches of RF signals having a 90° phase difference applied respectively, resulting in a complex configuration, bulky size, and 3 dB attenuation in efficiency. Additionally, an external discrete RF 90° hybrid (RF Hilbert transformer) or dual-channel RF source is often employed to realize the half-pi phase difference between the two RF channels, which not only introduces additional RF losses but also increases the overall cost, particularly at higher frequencies.

### SUMMARY OF THE INVENTION

This invention simplifies the generation of SSB signals by optical-delay-line-assisted compact and power-efficient single-drive modulators on thin-film lithium niobate. The optical delay line acts as photonic RF phase shifter with carefully designed on-chip optical delay line length ensured by the precise nano-fabrication process of integrated platform, which simplify the generation by removing the 90° RF hybrid and reducing the dual-drive configuration down to single-drive electrode, saving half of the space and energy.

According to a first aspect of the present invention, a single sideband signal generator is provided. The single sideband signal generator comprises: a modulator configured to generate a first and a second modulated optical signals which have equal amplitudes but opposite phases; and a sideband suppressing optical circuit including: a first optical delay line path coupled to the first modulation branch and configured to obtain a first photonic RF phase-shifted optical signal based on the first modulated optical signal; a first optical bypass line path coupled to second modulation branch and configured to obtain a first bypass optical signal based on the second modulated optical signal; and a first optical combiner coupled to the first optical delay line path and the first optical bypass line path and configured to combine the first photonic RF phase-shifted optical signal and the first bypass optical signal to obtain a first FC-SSB signal.

According to a second aspect of the present invention, a single sideband signal generator is provided. The single sideband signal generator comprises: a modulator configured to generate a first and a second modulated optical signals which have equal amplitudes but opposite phases; and a sideband suppressing optical circuit including: a first optical delay line path coupled to the first modulation branch and configured to obtain a first photonic RF phase-shifted optical signal based on the first modulated optical signal; a first optical bypass line path coupled to second modulation branch and configured to obtain a first bypass optical signal based on the second modulated optical signal; a second optical delay line path coupled to the second modulation branch and configured to obtain a second photonic RF phase-shifted optical signal based on the second modulated optical signal; a second optical bypass line path coupled to first modulation branch and configured to obtain a second bypass optical signal based on the first modulated optical signal; and an optical combining circuit configured to combine the first photonic RF phase-shifted optical signal, the first bypass optical signal, the second photonic RF phase-shifted optical signal and the second bypass optical signal to obtain a CS-SSB signal.

According to a third aspect of the present invention, a single sideband signal generator comprising the single sideband signal generator according to the first aspect and the single sideband signal generator according to the second aspect is provided. The provided SSB signal generator can perform both full-carrier SSB (FC-SSB) and carrier-suppressed SSB (CS-SSB) signals generation, achieving sideband suppression ratios of 22.1 dB and 22.5 dB, respectively, along with a 16.9 dB sideband-to-carrier suppression for CS-SSB. The generated SSB signals also exhibit good resistance to the frequency-selective power fading problem.

Compared to the previous schemes, the provided approach simplifies the structure by saving half of the space occupied by the redundant signal electrodes and also reducing the RF power consumption by half. Moreover, this scheme removes the RF hybrid and can be easily scaled to higher frequency domains without additional cost by appropriately designing the optical delay line length.

The provided SSB signal generation techniques could enable compact, low-cost, and power-efficient SSB signal generation for applications including direct detection systems, frequency-modulated continuous wave radar/LiDAR, frequency up/down conversion, optical vector network analyzers, and cold atom interferometer systems. In particular, the provided FC-SSB signal generator can be adopted in both incoherent and coherent direct detection systems (Kramers-Kronig receiver), especially suitable for near-distance optical communication application scenarios such as the communication among data centers and radio/video over fiber systems. They have also been demonstrated for optical vector network analyzers. The provided CS-SSB signal generator can be used for generating frequency-modulated continuous wave signals, which is a popular method in radar/LiDAR systems. They are also applied in frequency up/down conversion in microwave photonic systems and cold atom interferometer systems for precise frequency detuning.

### BRIEF DESCRIPTION OF THE DRAWINGS

Embodiments of the invention are described in more details hereinafter with reference to the drawings, in which:

FIG. 1 illustrates the schematic diagrams of conventional full-carrier SSB (FC-SSB) modulation based on a dual-drive Mach-Zehnder modulator (DDMZM) and carrier-suppressed SSB (CS-SSB) modulation using an IQ modulator;

FIG. 2A shows a simplified schematic diagram of a FC-SSB signal generator according to one embodiment of the present invention; FIG. 2B shows an opto-electronic circuit diagram for the SSB signal generator of FIG. 2A;

FIGS. 3A and 3B shows different configuration of the adjustable phase shifter according to various embodiments of the present invention;

FIG. 4A shows a simplified schematic diagram of a CS-SSB signal generator according to another embodiment of the present invention; FIG. 4B shows an opto-electronic circuit diagram for the SSB signal generator of FIG. 4A;

FIGS. 5A to 5D shows different configurations of the adjustable delay lines and phase shifters according to various embodiments of the present invention;

FIGS. 6A to 6C show three difference CS-SSB generation schemes respectively;

FIG. 7A shows a simplified schematic diagram of a signal generator according to another embodiment of the present invention; and FIG. 7B shows a microscopic picture of the signal generator fabricated according to the schematic diagram of FIG. 7A;

FIGS. 8A and 8B show the measured results of FC-SSB and CS-SSB generation; and

FIG. 9 shows resistance of the simplified SSB signal to the frequency-selective power fading problem of double sideband (DSB) signal.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In accordance with various aspects of the present invention, the present invention discloses a simplified generation scheme of compact and power-efficient single-sideband (SSB) modulation, facilitated by an on-chip optical delay line.

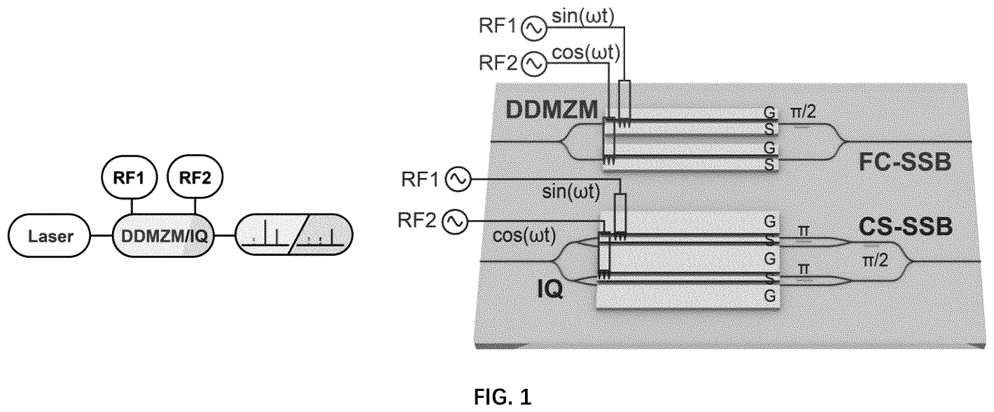

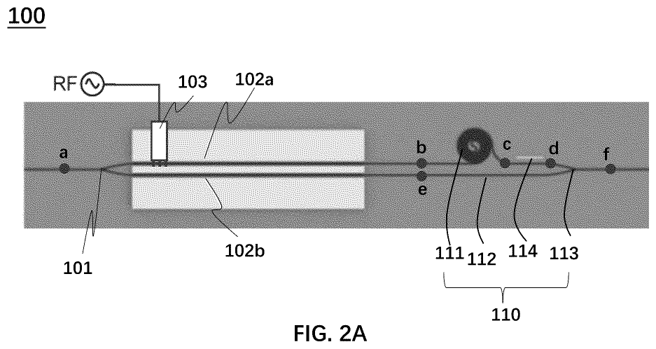

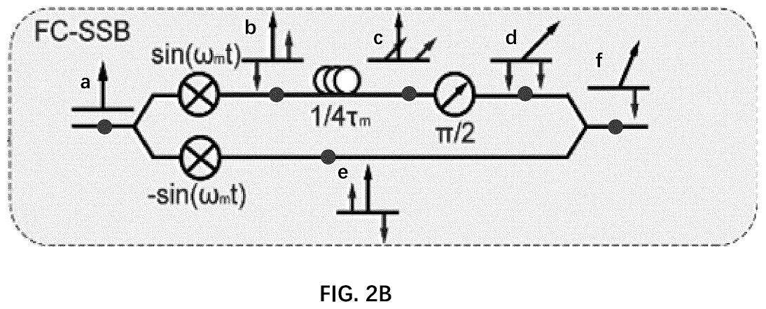

FIG. 2A shows a simplified schematic diagram of a SSB signal generator according to one embodiment of the present invention. Instead of using an RF 90° hybrid or dual-channel RF source (FIG. 1), the proposed approach utilizes a photonic RF phase shifter realized by an optical delay line.

As show in FIG. 2A, the SSB signal generator 100 comprises a first optical splitter 101 configured to split an optical input carrier signal into a first optical input signal and a second optical input signal; a first modulation branch 102a having an input coupled to a first output of the optical splitter 101 to receive the first optical input signal; a second modulation branch 102b having an input coupled to a second output of the optical splitter 101 to receive the second optical input signal; a modulator 103 configured to modulate the first and the second input signals at a modulation frequency to generate a first and a second modulated optical signals E1 and E2 which have equal amplitudes but opposite phases.

The SSB signal generator 100 further comprises a sideband suppressing optical circuit 110. The sideband suppressing optical circuit 110 includes: a first optical delay line path 111 coupled to the first modulation branch and configured to obtain a first photonic RF phase-shifted optical signal based on the first modulated optical signal; a first optical bypass line path 112 coupled to second modulation branch and configured to obtain a first bypass optical signal based on the second modulated optical signal; and a first optical combiner 113 coupled to the first optical delay line path 111 and the first optical bypass line path 112 and configured to combine the first photonic RF phase-shifted optical signal and the first bypass optical signal to obtain a first full-carrier SSB signal.

In some embodiments, the sideband suppressing optical circuit 110 further comprises an adjustable phase shifter 114 coupled to the optical delay line path 111 and configured for fine-tuning the first photonic RF phase-shifted optical signal.

The optical delay line path 111 acts as a photonic RF phase shifter, with a delay time τₘ equal to a quarter of the time period Tₘ of the modulation RF signal, that is, τₘ=¼ Tₘ. As the first and second modulated optical signals passes through the line paths 111 and 112 respectively, a 90° (or π/2 in radians) photonic RF phase shift can be induced between the two optical signals due to different path lengths between the line paths 111 and 112.

FIG. 2B shows an opto-electronic circuit diagram for the SSB signal generator 100 with indication of simplified spectra of optical signals at points a to f.

The input carrier signal (represented by spectrum at point a) is split into two branches and modulated by the single-drive modulator. The first modulated optical signal (represented by spectrum at point b) then passes through the optical delay line path 111 with a delay time equivalent to one-quarter of the period (τₘ) of the target RF frequency, introducing the 90° photonics RF phase shift to obtain the first photonic RF phase-shifted optical signal (represented by spectrum at point c).

An optical phase shift is then further induced by the adjustable phase shifter 114 to obtain the optical signal (represented by spectrum at point d) to ensure the destructive interference of the sidebands to be suppressed during recombination, where the suppressed sideband can be selected by adjusting the induced optical phase induced by the adjustable phase shifter.

The 90° photonics RF phase shift (or the delay time) is ensured by the carefully designed delay length. This benefits from the high-precision nano-fabrication process in the integrated platform, which is challenging to implement with conventional bulk-crystal modulators.

In some embodiments, the optical delay line path 111 is implemented with a thin film waveguide. The thin film waveguide may include a plurality of straight sections; and a plurality of circularly bending sections interposed between the plurality of straight sections to constitute the delay line. The bending sections and straight sections may be arranged to form arbitrary routing structures such as a spiral shape or the like can be used for delay. It should be understood that the routing structure may be other suitable routing configurations that can induce additive length with specific delay time in one branch compared to the other. The structures can be implemented on various material platforms, such as but not limited to, silicon, lithium niobate, lithium tantalate, gallium arsenide, indium phosphide, barium titanate, aluminum gallium arsenide, etc.

After recombination of the first photonic RF phase-shifted optical signal and the first bypass optical signal (represented by spectrum at point e), a full-carrier SSB signal (represented by spectrum at point f) is obtained. One of the sidebands is suppressed due to the destructive interference facilitated by the accumulated phase difference in the upper and lower sidebands induced in the photonic RF phase shifter. The suppressed sideband can be selected by adjusting the optical phase difference between the two branches, which can be achieved by applying a DC voltage to the modulation electrodes (not shown)

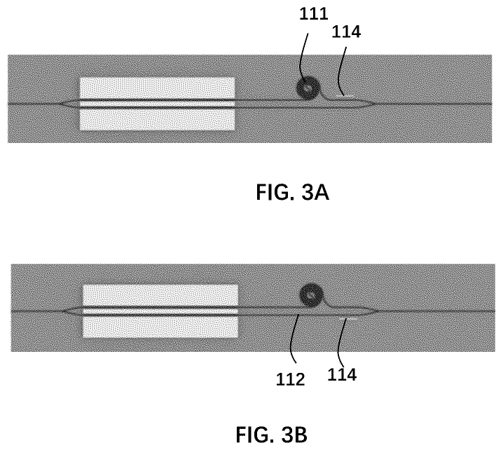

The adjustable phase shifter is utilized to ensure the correct phase for destructive interference and sideband selection. Referring to FIGS. 3A and 3B, the adjustable phase shifter 114 may be coupled to the first optical delay line path 111 as shown in FIG. 3A. Alternatively, the adjustable phase shifter 114 may be arranged along the first optical bypass line path 112 as shown in FIG. 3B and configured for fine-tuning the first bypass optical signal before recombination.

In some embodiments, the adjustable phase shifter 114 may be a thermo-optic phase shifter, an electro-optic phase shifter, a MEMS phase shifter, or a free-carrier depletion phase shifter. For example, the adjustable phase shifter 114 may be a thermal phase shifter including a waveguide; a cladding surrounding the waveguide; and a controllable heater disposed on the cladding and extending along the waveguide.

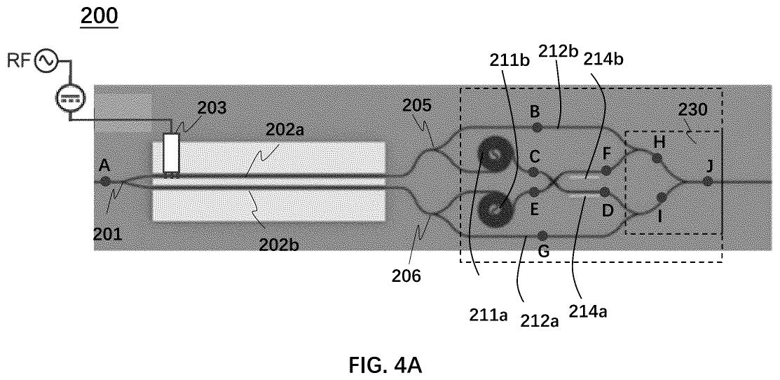

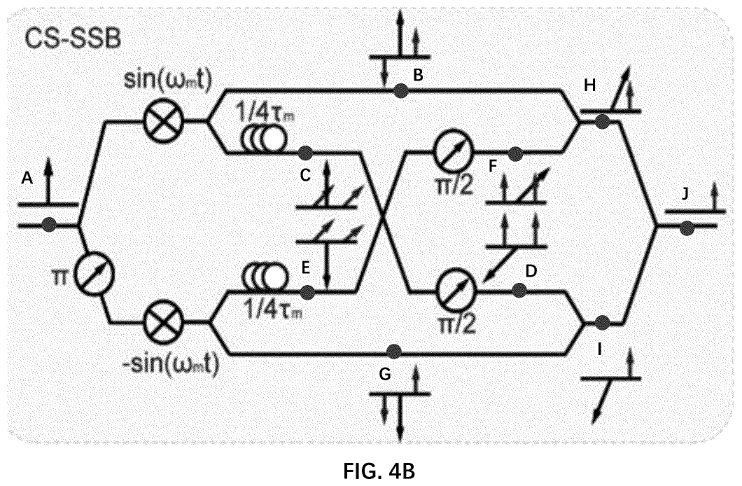

FIG. 4A shows a simplified schematic diagram of a SSB signal generator 200 according to another embodiment of the present invention.

The SSB signal generator 200 comprises a first optical splitter 201 configured to split an optical input carrier signal into a first optical input signal and a second optical input signal; a first modulation branch 202a having an input coupled to a first output of the optical splitter 201 to receive the first optical input signal; a second modulation branch 202b having an input coupled to a second output of the optical splitter 201 to receive the second optical input signal; a modulator 203 configured to modulate the first and the second input signals at a modulation frequency to generate a first and a second modulated optical signals which have equal amplitudes but opposite phases.

The SSB signal generator 200 further comprises a sideband suppressing optical circuit 210. The sideband suppressing optical circuit 210 includes: a first optical delay line path 211a coupled to the first modulation branch and configured to obtain a first photonic RF phase-shifted optical signal based on the first modulated optical signal; and a first optical bypass line path 212a coupled to second modulation branch and configured to obtain a first bypass optical signal based on the second modulated optical signal.

The sideband suppressing optical circuit 210 further comprises an adjustable phase shifter 214a coupled to the first optical delay line path 211a, and configured for fine-tuning the first photonic RF phase-shifted optical signal to ensure the destructive interference between the first photonic RF phase-shifted optical signal and the first bypass optical signal and/or selecting the sideband to be suppressed.

The sideband suppressing optical circuit 210 further includes: a second optical delay line path 211b coupled to the second modulation branch and configured to obtain a second photonic RF phase-shifted optical signal based on the second modulated optical signal; and a second optical bypass line path 212b coupled to first modulation branch and configured to obtain a second bypass optical signal based on the first modulated optical signal.

The sideband suppressing optical circuit 210 further includes an optical combining circuit 230 configured to combine the first photonic RF phase-shifted optical signal, the first bypass optical signal, the second photonic RF phase-shifted optical signal and the second bypass optical signal to obtain a CS-SSB signal.

In some embodiments, the SSB signal generator 200 further comprises a first optical coupler 205 configured to couple the first modulated signal from the first modulation branch 202a to the first optical delay line path 211a and the second optical bypass line path 212b respectively; and a second optical coupler 206 configured to couple the second modulated signal from the second modulation branch 202b to the first optical bypass line path 212a and the second optical delay line path 211b respectively.

In some embodiments, the sideband suppressing optical circuit 210 further comprises an adjustable phase shifter 214b coupled to the second optical delay line path 211b, and configured for fine-tuning the second photonic RF phase-shifted optical signal to ensure the destructive interference between the second photonic RF phase-shifted optical signal and the second bypass optical signal and/or selecting the sideband to be suppressed.

FIG. 4B shows an opto-electronic circuit diagram for the SSB signal generator 200 with indication of simplified spectra of optical signals at points A to J.

Referring to FIG. 4B, for carrier-free SSB signal generation, the optical carrier signal (represented by spectrum at point A) is first split into two branches and modulated by a single-drive modulator.

A phase shift of π is introduced by applying a DC voltage onto the electrodes of the modulator to adjust the bias point, which can alternatively be replaced by an additional adjustable phase shifter at the end of the recombination region. After modulation, each branch is further split into two, resulting in a total of four branches. Optical delay lines are then introduced between the top branches and bottom branches to induce the 90° (or π/2 in radians) photonic RF phase shift, with lengths following the same principle as the FC-SSB scheme.

More specifically, the first modulated optical signal (with a spectrum same as that at point B) passes through the optical delay line path 211a with a delay time equivalent to one-quarter of the period (τₘ) of the target RF frequency, introducing the 90° photonics RF phase shift to obtain the first photonic RF phase-shifted optical signal (represented by spectrum at point C). An optical phase shift is then further induced by the adjustable phase shifter 214a to obtain a fine-tuned optical signal (represented by spectrum at point D). After recombination of the fine-tuned optical signal and the first bypass optical signal (that is, the second modulated optical signal represented by spectrum at point G), a first full-carrier SSB signal (represented by spectrum at point I) is obtained.

The second modulated optical signal (with a spectrum same as that at point G) passes through the optical delay line path 211b with a delay time equivalent to one-quarter of the period (τₘ) of the target RF frequency, introducing the 90° photonics RF phase shift to obtain the second photonic RF phase-shifted optical signal (represented by spectrum at point E). An optical phase shift is then further induced by the adjustable phase shifter 214b to obtain the fine-tuned optical signal (represented by spectrum at point F). After recombination of the fine-tuned optical signal and the second bypass optical signal (that is, the first modulated optical signal represented by spectrum at point B), a second full-carrier SSB signal (represented by spectrum at point H) is obtained.

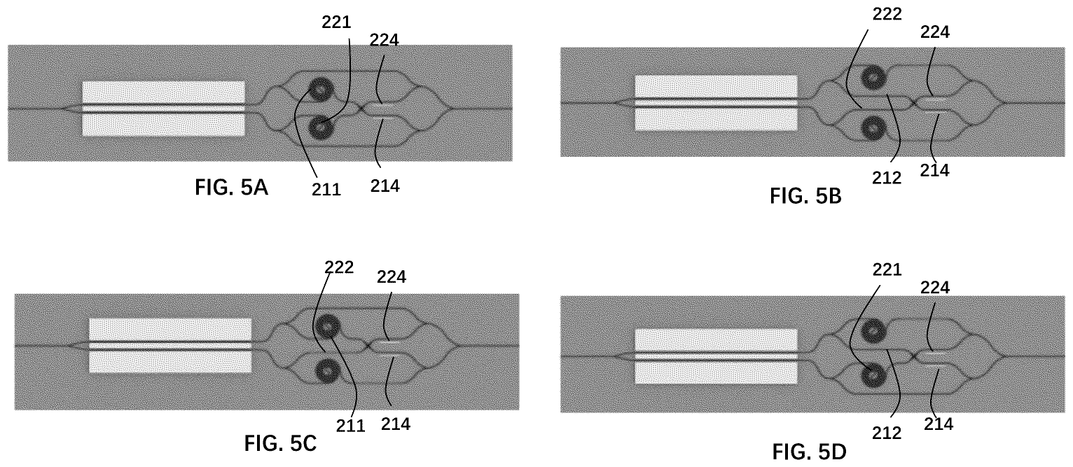

The adjustable phase shifter is utilized to cooperate with the optical delay line to ensure the correct phase for destructive interference and sideband selection. The first optical delay lines may be arranged in the lower branch (as shown in FIGS. 5A and 5C) or upper branch (as shown in FIGS. 5B and 5D). The second optical delay lines may be arranged in the upper branch (as shown in FIGS. 5A and 5D) or lower branch (as shown in FIGS. 5B and 5C). The adjustable phase shifter may be arranged in the branch with the optical delay line or alternatively arranged in the branch without the optical delay line path (i.e., the optical bypass line path). For examples, the adjustable phase shifter 214a/214b may be coupled to the optical delay line paths 211a/211b as shown in FIG. 5A. Alternatively, the adjustable phase shifter 214a/214b may be arranged along the optical bypass line paths 212a/212b as shown in FIG. 5B. Alternatively, the adjustable phase shifter 214a may be coupled to the optical delay line paths 211a while the adjustable phase shifter 214b may be arranged along the optical bypass line path 212b as shown in FIG. 5C. Alternatively, the adjustable phase shifter 214a may be arranged along the optical bypass line paths 212a while the adjustable phase shifter 214b may be coupled to the optical delay line path 211b as shown in FIG. 5D.

In some embodiments, each of the optical delay line paths 211a and 211b is implemented with a thin film waveguide. The thin film waveguide may include a plurality of straight sections; and a plurality of circularly bending sections interposed between the plurality of straight sections to constitute the delay line. The bending sections and straight sections may be arranged to form arbitrary routing structure such as a spiral shape or the like can be used for delay. The structures can be implemented on various material platforms, such as but not limited to, silicon, lithium niobate, lithium tantalate, gallium arsenide, indium phosphide, barium titanate, aluminum gallium arsenide, etc.

In some embodiments, each of the adjustable phase shifters 214a and 214b may be a thermo-optic phase shifter, an electro-optic phase shifter, a MEMS phase shifter, or a free-carrier depletion phase shifter. For example, the adjustable phase shifter 214a and 214b may be a thermal phase shifter including a waveguide; a cladding surrounding the waveguide; and a controllable heater disposed on the cladding and extending along the waveguide. It should be understood that the adjustable phase shifter may have other suitable structures to meat various situations.

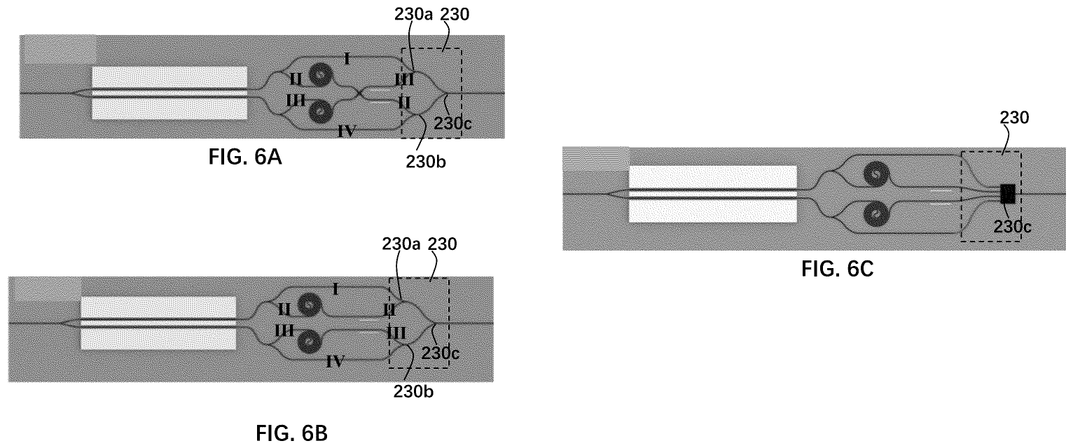

It should be noted that for CS-SSB generation, we can either suppress sideband first then suppress carrier by swapping branches II and III using waveguide crossing to combine branches I,III and combine branches II,IV first (as shown in FIG. 6A). More specifically, the optical combining circuit 230 may include: a first optical combiner 230a coupled to the second optical delay line path (branch III) and the first optical bypass line path (branch I) and configured to combine the second phase-shifted optical signal and the first bypass optical signal to obtain a first FC-SSB signal; a second optical combiner 230b coupled to the first optical delay line path (branch II) and the second optical bypass line path (branch IV) and configured to combine the second phase-shifted optical signal and the second bypass optical signal to obtain a second FC-SSB signal; and a third optical combiner 230c configured to combine the first FC-SSB signal and the second FC-SSB signal to obtain the CS-SSB signal.

Alternatively, we can do it in reverse, where branches I,II and III,IV are combined first straightforwardly without waveguide crossing (as shown in FIG. 6B). More specifically, the optical combining circuit 230 may include: a first optical combiner 230a coupled to the first optical delay line path (branch II) and the first optical bypass line path (branch I) and configured to combine the first photonic RF phase-shifted optical signal and the first bypass optical signal to obtain a first FC-SSB signal; a second optical combiner 230b coupled to the second optical delay line path (branch III) and the second optical bypass line path (branch IV) and configured to combine the second phase-shifted optical signal and the second bypass optical signal to obtain a second FC-SSB signal; and a third optical combiner 230c configured to combine the first FC-SSB signal and the second FC-SSB signal to obtain the CS-SSB signal.

In a further embodiment as shown in FIG. 6C, the branches I to IV may be combined simultaneously to generate the CS-SSB signal. More specifically, the optical combining circuit 230 may include an optical combiner configured to combine the first photonic RF phase-shifted optical signal, the first bypass optical signal, the second photonic RF phase-shifted optical signal and the second bypass optical signal to obtain the CS-SSB signal.

Once the delay lengths meet the requirement of 90° photonic RF phase shift, the FC-SSB and CS-SSB generation can be realized by applying different phase shift on phase shifters.

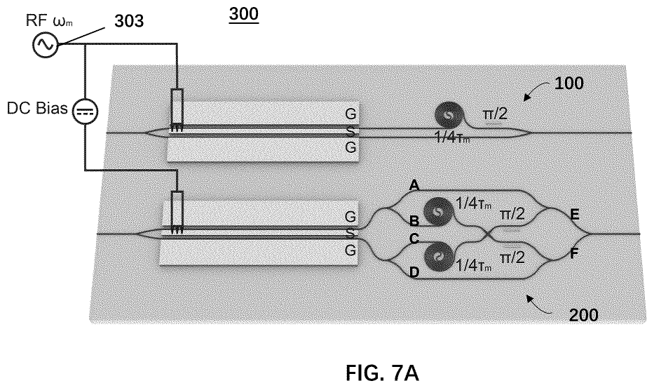

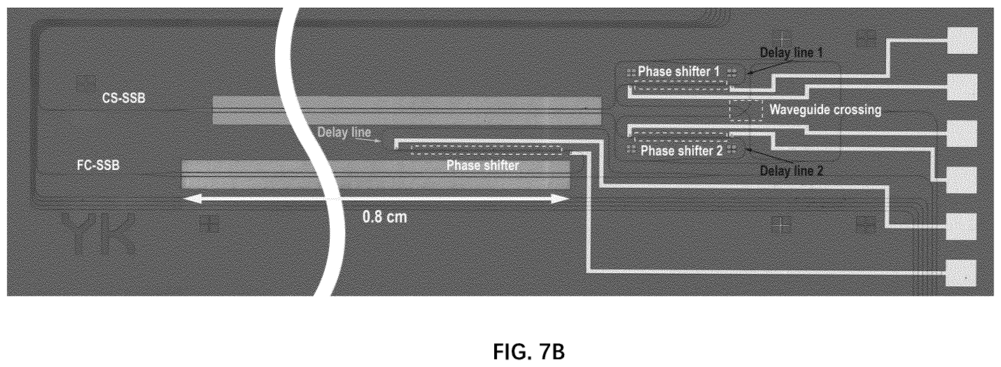

FIG. 7A shows a simplified schematic diagram of a signal generator 300 according to another embodiment of the present invention. FIG. 7B shows a microscopic picture of the signal generator fabricated according to the schematic diagram of FIG. 7A. As shown, the signal generator 300 is an integration of the FC-SSB signal generator 100 and the CS-SSB signal generator 200 and using a single RF signal generator for driving the modulators.

It should also be understood that the splitter 201, couplers 205 and 206 and combiners 203a-203c can be any suitable types of couplers (e.g. Y-shaped coupler, multi-mode interference (MMI) coupler, etc.).

### Single Sideband Modulation

The optical carrier is considered as e^{jω}^{₀}^{t}, where ω₀ is the carrier frequency. The RF signal is given by sin (ωₘt), with ωₘ denoting the modulation frequency.

For FC-SSB generation, the electric fields of the light, which is split into two branches and modulated by the electric field along both sides of the signal electrode, can be expressed as:

$${E}_{1} = \frac{{A}_{0}}{2} {e}^{j {ω}_{0} t} {e}^{{β sin ω}_{m} t} \qquad ( 1 )$$

$${E}_{2} = \frac{{A}_{0}}{2} {e}^{j {ω}_{0} t} {e}^{- {β sin ω}_{m} t} \qquad ( 2 )$$

where E₁ and E₂ are the electric fields of two branches after modulation, A₀ is the amplitude of the input electric field, β denotes the modulation strength. The modulation of the upper and lower branches by opposite electric fields results in their modulation terms with opposite signs. After the modulation, one of the branches passes through an optical delay line with a delay time τₘ equivalent to a quarter of the period of the target modulation frequency

$$( \frac{π}{2 {ω}_{m}} ) .$$

Subsequently, the phase is adjusted by a thermal phase shifter, introducing a phase shift of φₜ. The electric field after the delay and the phase shifting can be expressed as:

$$\begin{matrix}{E}_{1}^{′} = \frac{{A}_{0}}{2} {e}^{j {ω}_{0} ( t + \frac{π}{2 {ω}_{m}} )} {e}^{β sin [ {ω}_{m} ( t + \frac{π}{2 {ω}_{m}} ) ]} {e}^{j {φ}_{t}} \\ = \frac{{A}_{0}}{2} {e}^{j {ω}_{0} ( t + \frac{π}{2 {ω}_{m}} )} {e}^{β sin ( {ω}_{m} t + \frac{π}{2} )} {e}^{j {φ}_{t}} \\ = \frac{{A}_{0}}{2} {e}^{j {ω}_{0} ( t + \frac{π}{2 {ω}_{m}} )} {e}^{β cos ( {ω}_{m} t )} {e}^{j {φ}_{t}}\end{matrix} \qquad ( 3 )$$

The Fourier transform of the combination of two branches can be expanded using Jacobi-Anger expansion as:

$$\begin{matrix}F ( {E}_{1}^{′} + {E}_{2} ) = \frac{{A}_{0}}{2} [ δ ( ω - {ω}_{0} ) {e}^{\frac{j {ω}_{0} π}{2 {ω}_{m}}} * {\int }_{- ∞}^{∞} {e}^{β cos ( {ω}_{m} t )} {e}^{- i ω t} {e}^{j {φ}_{t}} dt + \\ δ ( ω - {ω}_{0} ) * {\int }_{- ∞}^{∞} {e}^{- β sin ( {ω}_{m} t )} {e}^{- i ω t} dt ] \\ = \frac{{A}_{0}}{2} [ {\sum }_{n = - ∞}^{∞} {i}^{n} {e}^{j ( \frac{{ω}_{0} π}{2 {ω}_{m}} + {φ}_{t} )} {J}_{n} ( β ) δ ( ω - n {ω}_{m} - {ω}_{0} ) + \\ {\sum }_{n = - ∞}^{∞} {( - 1 )}^{n} {J}_{n} ( β ) δ ( ω - n {ω}_{m} - {ω}_{0} ) ]\end{matrix} \qquad ( 4 )$$

If we only consider the first-order sidebands, then the output will be:

$$\begin{matrix}F ( {E}_{1}^{′} + {E}_{2} ) = \frac{{A}_{0}}{2} \{ [ {i}^{- 1} {J}_{- 1} ( β ) δ ( ω + {ω}_{m} - {ω}_{0} ) + {J}_{0} ( β ) δ ( ω - {ω}_{0} ) + \\ {iJ}_{1} ( β ) δ ( ω - {ω}_{m} - {ω}_{0} ) ] {e}^{j ( \frac{{ω}_{0} π}{2 {ω}_{m}} + {φ}_{t} )} + [ - {J}_{- 1} ( β ) δ ( ω + \\ {ω}_{m} - {ω}_{0} ) + {J}_{0} ( β ) δ ( ω - {ω}_{0} ) - {J}_{1} ( β ) δ ( ω - {ω}_{m} - {ω}_{0} ) ] \} \\ = \frac{{A}_{0}}{2} \{ \{ {e}^{j [ ( \frac{{ω}_{0} π}{2 {ω}_{m}} + {φ}_{t} ) - \frac{π}{2} ]} - 1 \} {J}_{- 1} ( β ) δ ( ω + {ω}_{m} - {ω}_{0} ) + \\ [ {e}^{j ( \frac{{ω}_{0} π}{2 {ω}_{m}} + {φ}_{t} )} + 1 ] {J}_{0} ( β ) δ ( ω - {ω}_{0} ) + \\ \{ {e}^{j [ ( \frac{{ω}_{0} π}{2 {ω}_{m}} + {φ}_{t} ) + \frac{π}{2} ]} - 1 \} {J}_{1} ( β ) δ ( ω - {ω}_{m} - {ω}_{0} ) \}\end{matrix} \qquad ( 5 )$$

which can be simplified as:

$$F ( {E}_{1}^{′} + {E}_{2} ) = {J}_{0} ( β ) \frac{( i + 1 ) {A}_{0}}{2} δ ( ω - {ω}_{0} ) - {A}_{0} {J}_{1} ( β ) δ ( ω - {ω}_{m} - {ω}_{0} ) \qquad ( 6 )$$

where the negative first-order sideband is canceled out when

$$\frac{{ω}_{0} π}{2 {ω}_{m}} + {φ}_{t} = \frac{π}{2} \pm 2 k π \qquad ( 7 )$$

k is an integral. The positive first-order sideband will be cancelled out instead when it equals

$$- \frac{π}{2} \pm 2 k π .$$

The CS-SSB generation can be derived in a similar way. The Fourier transform (considering only the first sidebands) of the combination of four branches [labeled a, b, c and d as shown in FIG. 1 (b) in the main text] after passing through the delay lines and thermal phase shifters can be written as:

$$\begin{matrix}F ( {E}_{a} + {E}_{b} + {E}_{c} + {E}_{d} ) = \frac{{A}_{0}}{4} \{ \{ 1 + {e}^{j [ ( \frac{{ω}_{0} π}{2 {ω}_{m}} + {φ}_{t 2} ) - \frac{π}{2} ]} + ( - \\ {1 )}^{n} {e}^{j [ ( \frac{{ω}_{0} π}{2 {ω}_{m}} + {φ}_{t 1} ) - \frac{π}{2} ]} {e}^{j {φ}_{dc}} + ( - \\ {1 )}^{n} {e}^{j {φ}_{dc}} \} {J}_{- 1} ( β ) δ ( ω + {ω}_{m} - {ω}_{0} ) + \\ ( 1 + {e}^{j ( \frac{{ω}_{0} π}{2 {ω}_{m}} + {φ}_{t 2} )} + {( - 1 )}^{n} {e}^{j ( \frac{{ω}_{0} π}{2 {ω}_{m}} + {φ}_{t 1} )} {e}^{j {φ}_{dc}} + \\ {( - 1 )}^{n} {e}^{j {φ}_{dc}} ) {J}_{0} ( β ) δ ( ω - {ω}_{0} ) + \\ \{ 1 + {e}^{j [ ( \frac{{ω}_{0} π}{2 {ω}_{m}} + {φ}_{t 2} ) + \frac{π}{2} ]} + ( - \\ {1 )}^{n} {e}^{j [ ( \frac{{ω}_{0} π}{2 {ω}_{m}} + {φ}_{t 1} ) + \frac{π}{2} ]} {e}^{j {φ}_{dc}} + ( - \\ {1 )}^{n} {e}^{j {φ}_{dc}} \} {J}_{1} ( β ) δ ( ω - {ω}_{m} - {ω}_{0} ) \}\end{matrix} \qquad ( 8 )$$

where φₜ₁, φₜ₂, and φ_{dc} are optical phase shifts induced by the two thermal phase shifter and the DC voltage applied to the modulation electrode. The output can be simplified as:

$$F ( {E}_{a} + {E}_{b} + {E}_{c} + {E}_{d} ) = {A}_{0} {J}_{- 1} ( β ) δ ( ω + {ω}_{m} - {ω}_{0} ) \qquad ( 9 )$$

where the positive first-order sideband and carrier are canceled out when

$$\frac{{ω}_{0} π}{2 {ω}_{m}} + {φ}_{t 1} = \frac{{ω}_{0} π}{2 {ω}_{m}} + {φ}_{t 2} = \frac{π}{2} \pm 2 k π \qquad ( 10 )$$

$${φ}_{dc} = π \pm 2 k π \qquad ( 11 )$$

k is an integral. The negative first-order sideband will be canceled out instead when the terms in equation (10) equal

$$- \frac{π}{2} \pm 2 k π .$$

In conventional SSB generation schemes, two RF signals with half-phase shifts are applied to the parallel phase or amplitude modulators for FC-SSB and CS-SSB generation. Consequently, only half of the power contributes to modulation in these parallel schemes. If we assume that the total RF power is the same as that of the delay-line-assisted SSB modulator according to the present invention, then each phase modulator shares half of the total power. Since the modulation strength is proportional to the modulation voltage, the delay-line-assisted scheme provided by the present invention can equivalently save half of the power to achieve the same modulation strength.

### Optical Delay Line Design

The delay time is carefully designed under the design aim of achieving the required delay time of

$$\frac{π}{2 {ω}_{m}}$$

for destructive interference of the first sidebands by controlling the additional routing length of one branch relative to another. Due to the anisotropy nature of the material, the waveguide in the y-z plane of the x-cut LN exhibits different group indices at various crystal routing angles, leading to a nonuniform delay at different locations along the bend. To improve the estimation and control of the delay length, straight waveguides and circular bends are utilized instead of spirals for routing.

The delay time of the bending is calculated by integrating the group indices along the routing crystal angles:

$$τ = {\int }_{0}^{\frac{π}{2}} \frac{r \cdot {n}_{g} ( θ )}{c} d θ \qquad ( 12 )$$

where τ is the delay of the bending, r is the radius of the circular bending, n_{g}(θ) the group index at angle θ.

Taking the delay line of FC-SSB targeting at 25 GHz as an example, Table 1 shows the lengths and corresponding delay time of each segment of the two branches. The delay time difference between the two branches is 10 ps, which is a quarter of the time period of the 25 GHz signal.

TABLE 1
Lengths and delay time of structures
in FC-SSB generation at 25 GHz

| | | Length | Delay time (ps) | |
|---|---|---|---|---|
| Branches | Structures | (μm) | Component | Sum |
| branch 1 | circular bending × 6 | 753 | 5.8 | 13.7 |
| | waveguide (y-axis) | 140 | 1.1 | |
| | waveguide (z-axis) | 906 | 6.8 | |
| branch 2 | waveguide (z-axis) | 500 | 3.7 | 3.7 |

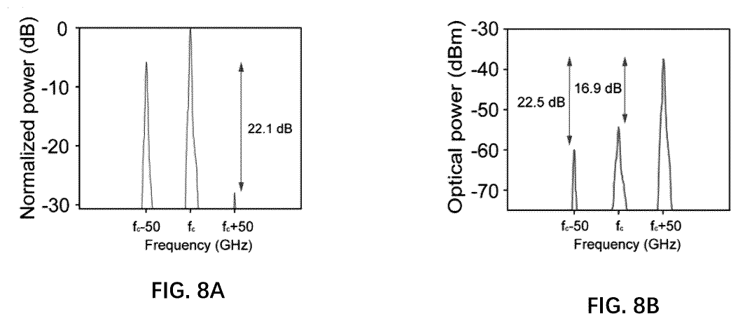

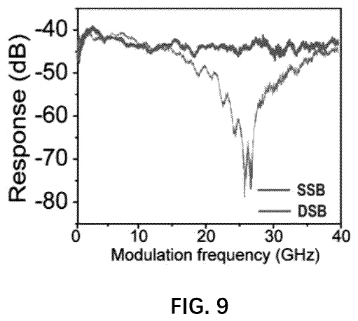

FIGS. 8A and 8B present the measured results of FC-SSB and CS-SSB generation, showing sideband suppression ratios of 22.1 dB and 22.5 dB respectively for FC-SSB and CS-SSB, along with a 16.9 dB sideband-to-carrier suppression for CS-SSB. Furthermore, FIG. 9 exhibits the good resistance of the simplified SSB signal to the frequency-selective power fading problem.

The foregoing description of the present invention has been provided for the purposes of illustration and description. It is not intended to be exhaustive or to limit the invention to the precise forms disclosed. Many modifications and variations will be apparent to the practitioner skilled in the art.

What is claimed is:

1. A single sideband signal generator, comprising:
a modulator configured to generate a first and a second modulated optical signals which have equal amplitudes but opposite phases; and
a sideband suppressing optical circuit including:
a first optical delay line path coupled to the first modulation branch and configured to obtain a first photonic RF phase-shifted optical signal based on the first modulated optical signal;
a first optical bypass line path coupled to second modulation branch and configured to obtain a first bypass optical signal based on the second modulated optical signal; and
a first optical combiner coupled to the first optical delay line path and the first optical bypass line path and configured to combine the first photonic RF phase-shifted optical signal and the first bypass optical signal to obtain a first full-carrier single sideband signal.

2. The single sideband signal generator according to claim 1, wherein the first optical delay line path is based on a thin film waveguide made of any one of: silicon, lithium niobate, lithium tantalate, gallium arsenide, indium phosphide, barium titanate, and aluminium gallium arsenide.

3. The single sideband signal generator according to claim 1, wherein the first sideband suppressing optical circuit further comprises an adjustable phase shifter coupled to the first optical delay line path, and configured for fine-tuning the first photonic RF phase-shifted optical signal.

4. The single sideband signal generator according to claim 3, wherein the adjustable phase shifter is a thermo-optic phase shifter, an electro-optic phase shifter, a MEMS phase shifter, or a free-carrier depletion phase shifter.

5. The single sideband signal generator according to claim 1, wherein the first sideband suppressing optical circuit further comprises an adjustable phase shifter coupled to the first bypass line path, and configured for fine-tuning the first bypass optical signal.

6. The single sideband signal generator according to claim 5, wherein the adjustable phase shifter is a thermo-optic phase shifter, an electro-optic phase shifter, a MEMS phase shifter, or a free-carrier depletion phase shifter.

7. A single sideband signal generator, comprising:
a modulator configured to generate a first and a second modulated optical signals which have equal amplitudes but opposite phases;
a sideband suppressing optical circuit including:
a first optical delay line path coupled to the first modulation branch and configured to obtain a first photonic RF phase-shifted optical signal based on the first modulated optical signal;
a first optical bypass line path coupled to second modulation branch and configured to obtain a first bypass optical signal based on the second modulated optical signal;
a second optical delay line path coupled to the second modulation branch and configured to obtain a second photonic RF phase-shifted optical signal based on the second modulated optical signal;
a second optical bypass line path coupled to first modulation branch and configured to obtain a second bypass optical signal based on the first modulated optical signal; and
an optical combining circuit configured to combine the first photonic RF phase-shifted optical signal, the first bypass optical signal, the second photonic RF phase-shifted optical signal and the second bypass optical signal to obtain a carrier-suppressed single sideband signal.

8. The single sideband signal generator according to claim 7, wherein the optical combining circuit includes an optical combiner configured to combine the first photonic RF phase-shifted optical signal, the first bypass optical signal, the second photonic RF phase-shifted optical signal and the second bypass optical signal to obtain the carrier-suppressed single sideband signal.

9. The single sideband signal generator according to claim 7, wherein the optical combining circuit includes:
a first optical combiner coupled to the first optical delay line path and the first optical bypass line path and configured to combine the first photonic RF phase-shifted optical signal and the first bypass optical signal to obtain a first full-carrier single sideband signal;
a second optical combiner coupled to the second optical delay line path and the second optical bypass line path and configured to combine the second phase-shifted optical signal and the second bypass optical signal to obtain a second full-carrier single sideband signal; and
a third optical combiner configured to combine the first full-carrier single sideband signal and the second full-carrier single sideband signal to obtain the carrier-suppressed single sideband signal.

10. The single sideband signal generator according to claim 7, wherein the optical combining circuit includes:
a first optical combiner coupled to the first optical delay line path and the second optical bypass line path and configured to combine the first photonic RF phase-shifted optical signal and the second bypass optical signal to obtain a first full-carrier single sideband signal;
a second optical combiner coupled to the second optical delay line path and the first optical bypass line path and configured to combine the second phase-shifted optical signal and the first bypass optical signal to obtain a second full-carrier single sideband signal; and
a third optical combiner configured to combine the first full-carrier single sideband signal and the second full-carrier single sideband signal to obtain the carrier-suppressed single sideband signal.

11. The single sideband signal generator according to claim 7, wherein each of the first and second optical delay line paths is based on a thin film waveguide made of any one of: silicon, lithium niobate, lithium tantalate, gallium arsenide, indium phosphide, barium titanate, and aluminium gallium arsenide.

12. The single sideband signal generator according to claim 7, further comprising:
a first adjustable phase shifter coupled to the first optical delay line path, and configured for fine-tuning the first photonic RF phase-shifted optical signal; and
a second adjustable phase shifter coupled to the second optical delay line path, and configured for fine-tuning the second photonic RF phase-shifted optical signal.

13. The single sideband signal generator according to claim 12, wherein each of the first and second adjustable phase shifters is a thermo-optic phase shifter, an electro-optic phase shifter, a MEMS phase shifter, or a free-carrier depletion phase shifter.

14. The single sideband signal generator according to claim 7, further comprising:
a first adjustable phase shifter coupled to the first optical bypass line path, and configured for fine-tuning the first bypass optical signal; and
a second adjustable phase shifter coupled to the second optical bypass line path, and configured for fine-tuning the second bypass optical signal.

15. The single sideband signal generator according to claim 14, wherein each of the first and second adjustable phase shifters is a thermo-optic phase shifter, an electro-optic phase shifter, a MEMS phase shifter, or a free-carrier depletion phase shifter.

16. The single sideband signal generator according to claim 7, further comprising:
a first adjustable phase shifter coupled to the first optical delay line path, and configured for fine-tuning the first photonic RF phase-shifted optical signal; and
a second adjustable phase shifter coupled to the second optical bypass line path, and configured for fine-tuning the second bypass optical signal.

17. The single sideband signal generator according to claim 16, wherein each of the first and second adjustable phase shifters is a thermo-optic phase shifter, an electro-optic phase shifter, a MEMS phase shifter, or a free-carrier depletion phase shifter.

18. The single sideband signal generator according to claim 7, further comprising:
a first adjustable phase shifter coupled to the first optical bypass line path, and configured for fine-tuning the first bypass optical signal; and
a second adjustable phase shifter coupled to the second optical delay line path, and configured for fine-tuning the second photonic RF phase-shifted optical signal.

19. The single sideband signal generator according to claim 18, wherein each of the first and second adjustable phase shifters is a thermo-optic phase shifter, an electro-optic phase shifter, a MEMS phase shifter, or a free-carrier depletion phase shifter.

20. A single sideband signal generator, comprising the single sideband generator of claim 1 and single sideband generator of claim 7.
